(19) United States
(12) Patent Application Publication
(10) Pub. No.: US 2008/0172246 A1
(43) Pub. Date: Jul. 17, 2008

(54) Systems, methods and computer product for disease risk reduction, education and assessment

(76) Inventors: James D. Larkin, Seattle, WA (US); Freya Spielberg, Seattle, WA (US); Ann E. Kurth, Seattle, WA (US); Tycen J. Hopkins, Seattle, WA (US); Carter D. Wickstrom, Seattle, WA (US); Jae S. Choi, Mercer Island, WA (US)

Correspondence Address: BLACK LOWE & GRAHAM, PLLC, 701 FIFTH AVENUE, SUITE 4800, SEATTLE, WA, 98104, US

(21) Appl. No.: 11/268,754

(22) Filed: Oct. 26, 2005

Related U.S. Application Data
(60) Provisional application No. 60/622,529, filed on Oct. 26, 2004.

(51) Int. Cl. G06Q 50/00

(52) U.S. Cl. 705/2; 434/262; 707/104.1

(57) ABSTRACT

Systems, methods and a software product for disease reduction education and risk assessment are disclosed. In one embodiment, a system for computer-assisted disease risk assessment and education includes a processor that generates at least a plurality of questions directed to a disease risk assessment for a user. Based upon responses received from a user, the processor is further operable to generate one or more plans configured to prospectively guide the risk behavior and sexual activity of the user. At least one personal data entry and display device (PDDA) is communicatively coupled to the processor, that is operable to at least display the plurality of questions and to accept corresponding responses from the user.

### REFERENCE TO RELATED APPLICATION

This application claims priority to Provisional Application Ser. No. 60/622,529, entitled “COMPUTER ASSESSMENT AND RISK REDUCTION EDUCATION FOR HIV/STDs”, filed on Oct. 26, 2004, which is incorporated by reference herein in its entirety.

### COPYRIGHT NOTICE

This disclosure may be protected under United States and International Copyright Laws. © 2005 Resources Online. All Rights Reserved. A portion of the disclosure of this patent document contains material that is subject to copyright protection. The copyright owner has no objection to the facsimile reproduction by anyone of the patent document or the patent disclosure after formal publication by the USPTO, as it appears in the Patent and Trademark Office patent file or records, but otherwise reserves all copyright rights whatsoever.

### FIELD OF THE INVENTION

This invention relates generally to information management systems and methods for disease management, and, more specifically, to computer-based systems and methods for information input, analysis and output related to the management and assessment of HIV/STD affected individuals.

### BACKGROUND OF THE INVENTION

The Acquired Immune Deficiency Syndrome (AIDS) is recognized as a significant threat to public health worldwide. In the United States alone, it is estimated that about 800,000 to 900,000 individuals are HIV-positive. Further, it is estimated that about 300,000 individuals are currently living with AIDS, with approximately about 40,000 new infections being confirmed each year. Accordingly, by the mid-1990s, AIDS had become a significant health threat to HIV affected individuals.

Although recently developed treatment methods have significantly improved survival rates for individuals having AIDS, the number of individuals living with an HIV infection has been steadily increasing. Since behavioral factors are strongly implicated in communicating the HIV virus between individuals, modification of these behavioral patterns is of critical importance. Accordingly, past modification efforts have resulted in behavioral changes for many individuals and have contributed to an overall reduction in the rate of increase of HIV-infected individuals.

Nevertheless, certain high-risk behavioral factors are still continuing, which generally include unprotected sexual contact, community use of hypodermic syringes among intravenous drug users, as well as other known factors. Since the foregoing behavioral patterns involve sensitive personal disclosures, the dissemination of valuable information regarding HIV, and other sexually-transmitted diseases (STD's) may not reach individuals that are significantly at risk of contracting HIV. Moreover, potentially high-risk behaviors are continuing in populations that are not English speaking, or that have limited literacy skills.

Consequently, there currently exists a need for systems and methods that increase the likelihood of confidential disclosures for individuals at-risk of contracting or communicating a disease. Moreover, there exists a need for systems that permit at-risk individuals having limited and/or different language skills to participate. Still further, there is a need for systems and methods for generating a plan that may be used to prospectively guide the behavioral patterns of the at-risk individual.

### SUMMARY

The present invention comprises systems, methods and a software product for disease reduction education and/or risk assessment. In one aspect, a system for computer-assisted disease risk assessment and/or education includes a processor that generates one or more questions directed to a disease risk assessment for a user. Based upon responses received from a user, the processor is further operable to generate one or more plans configured to prospectively guide the risk behavior and sexual activity of the user. At least one personal data entry and display device (PDDA) is communicatively coupled to the processor, that is operable to at least display the one or more questions and to accept corresponding responses from the user.

### BRIEF DESCRIPTION OF THE DRAWINGS

Embodiments of the present invention are described in detail below with reference to the following drawings.

FIG. 1 is a block diagrammatic view of a computer-assisted disease risk assessment and education system 10 according to an embodiment of the invention;

FIG. 2 is a block diagrammatic view of a software product that provides disease risk assessment and education services, according to another embodiment of the invention;

FIG. 3 is a user interface generated by the intake module of the software product of FIG. 2, according to another embodiment of the invention;

FIG. 4 is a user interface generated by the intake module of the software product of FIG. 2, according to another embodiment of the invention;

FIG. 5 is a user interface generated by the risk assessment module of the software product of FIG. 2, according to another embodiment of the invention;

FIG. 6 is a user interface generated by the risk assessment module of the software product of FIG. 2, according to another embodiment of the invention;

FIGS. 7a through 7g are user interfaces generated by the risk assessment module of the software product of FIG. 2, according to another embodiment of the invention;

FIG. 8 is a user interface generated by the risk assessment module of the software product of FIG. 2, according to another embodiment of the invention;

FIG. 9 is still another user interface that is generated by the risk assessment module of FIG. 2, according to another embodiment of the invention;

FIG. 10 is still another user interface that is generated by the risk feedback module of FIG. 2, according to another embodiment of the invention;

FIG. 11a through 11b are still other user interfaces that are generated by the risk feedback module of FIG. 2, according to another embodiment of the invention;

FIG. 12, a user interface generated by the risk reduction module of FIG. 2, according to another embodiment of the invention;

FIG. 13 is another user interface generated by the risk reduction module of FIG. 2, according to another embodiment of the invention;

FIG. 14 is a user interface generated by the risk reduction module of FIG. 2, according to another embodiment of the invention; and

FIG. 15a is another user interface that is generated by the risk reduction module of FIG. 2, according to another embodiment of the invention;

FIG. 15b is a block diagrammatic view of a software implementation for a method of disease risk assessment and education, according to another embodiment of the invention; and

FIG. 16 is a flowchart that describes a method of disease risk assessment and education, according to another embodiment of the invention.

### DETAILED DESCRIPTION

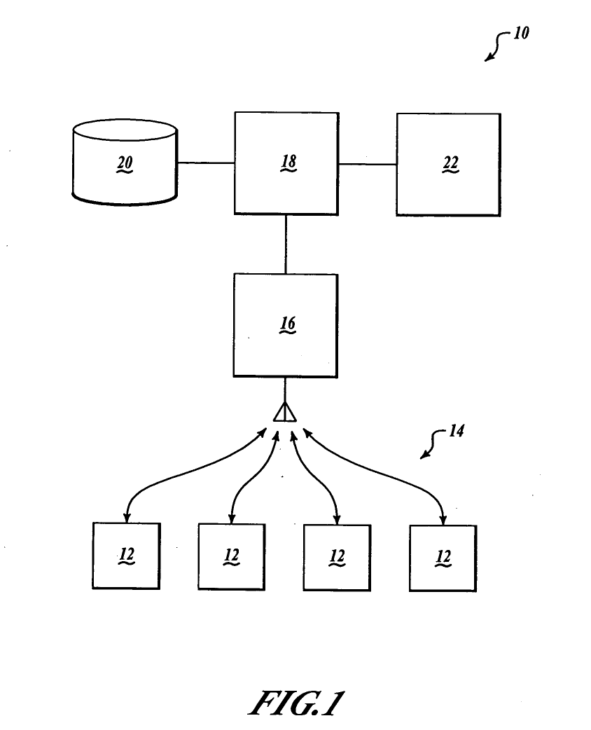

The present invention relates to systems, methods and a computer product for disease risk reduction education and for the assessment of at-risk individuals. Many specific details of certain embodiments of the invention are set forth in the following description and in FIGS. 1 through 16 to provide a thorough understanding of such embodiments. One skilled in the art, however, will understand that the present invention may have additional embodiments, or that the present invention may be practiced without several of the details described in the following description.

FIG. 1 is a block diagrammatic view of a computer-assisted disease risk assessment and education system 10 according to an embodiment of the invention. The system 10 includes at least one personal data entry and display device (PDDE) 12. The PDDE 12 is suitably configured to support computer assisted interviewing (CAI) so that pertinent information may be obtained from a user of the PDDE 12. The PDDE 12 may thus be configured to support the known audio computer-assisted self-interviewing (ACASI) presentational format, which advantageously permits audio and video communications with the user, so that conventional pencil and paper data collection is unnecessary. Although the PDDA 12 may include a desktop or a lap top personal computing (PC) device having a suitable visual display, in a particular embodiment of the present invention, the PDDA 12 is a tablet PC device that includes a display surface that is operable to accept a response from the user that is impressed on the display by touching the display with a user's finger, a stylus, or by other suitable means. One suitable tablet PC device is the HP-COMPAQ TC4200 Tablet PC, available from the Hewlett Packard Company of Palo Alto Calif., although other suitable alternatives exist. The tablet PC may also be configured to use the MICROSOFT WINDOWS XP Tablet PC Edition 2005 operating system, available from the Microsoft Corporation of Redmond, Wash., although other presently available operating systems may also be used. The use of a tablet PC advantageously permits individuals having limited experience with conventional data input devices such as keyboard, a mouse, or other similar devices, to easily provide requested data to the system. Still further, the tablet PC may be configured to display selected motion and audio content to the user, which may be made available to the user by suitable video and audio encoding methods, such as MPEG encoding methods. One suitable encoding method is provided in the WINDOWS Media Video applications software, available from the Microsoft Corporation. The tablet PC may also be configured to permit “ink-enabled” content to be entered on a display surface of the tablet PC device, so that handwritten content provided by the user may be input to the tablet PC device. For example, the MICROSOFT Tablet SDK application software, also available from Microsoft Corporation, allows handwritten content and/or graphical material to be entered into the tablet PC device. In any event, when more than one PDDA 12 is simultaneously in use, the respective PDDA's 12 are generally mutually spaced apart and/or mutually physically concealed from one another by positioning the PDDA's 12 in individual private areas, such as, for example, in private kiosks, so that users may enter and view data displayed on the PDDA 12 in relative privacy.

The system 10 also includes a communications system 14 that is operable to support wireless communications between the at least one PDDA 12 and a communications port 16. Accordingly, the PDDA 12 may be configured with a suitable network interface card (NIC) so that the PDDA 12 may exchange data signals with the communications port 16. The communications system 14 may use any suitable wireless communications mode, such as, for example, radio frequency (RF) or infrared (IR) modes. The communication system 14 may include a local area network (LAN) that provides wireless communications within a relatively limited area. Alternately, the communications system may include at least a portion of a wide area network (WAN) that includes other LANs that are geographically spaced apart from the communications system 14, and coupled by a telecommunications network, such as a telephone line, or even the Internet. In any event, the data signals communicated by the communications system 14 are suitably encrypted to ensure that the communicated data remains secure.

Still referring to FIG. 1, the communications port 16 is coupled to a processor 18. The processor 18 may include any suitable computing device that is operable to receive programmed instructions and data, and to process the data according to the received instructions. In particular, the processor 18 is configured to host and execute a plurality of software modules that are operable to provide computer assisted risk assessment and education to a user of the PDDA 12. Briefly, and in general terms, the processor is configured to communicate suitable questions to the user through the PDDA 12, and to receive and process the corresponding responses to the questions in order to determine a generalized risk assessment, and to generate one or more plans that are operable to prospectively guide the risk behavior and sexual activity of the user. The software modules will be described in greater detail below. The processor 18 may be a mainframe-computing device, or it may be a personal computing device, such as a desktop computing device. Selected peripheral devices may also be coupled to the processor 18, which for clarity of illustration, are not shown in FIG. 1. The selected peripheral devices are operable to permit a user to communicate with the processor 18, and may accordingly include a display device, a keyboard, a pointing device such as a mouse, or other similar devices, a speaker and/or microphone that permit audio communications with the processor 18, as well as other known peripheral devices. The processor 18 is generally remotely positioned from the PDDA 12 and/or otherwise sequestered or encrypted relative to the PDDA 12 so that, optionally, processing operations performed by the processor 18 may not be observed or accessed by unauthorized personnel.

The system 10 may also includes a data storage unit 20 that is operable to store information obtained from the PDDA 12, and to store processed results generated by the processor 18. The data storage unit 20 may include any known device that is operable to provide a mass storage capability, such as a magnetic disk drive. Alternately, other known solid-state memory devices, such as flash memory modules, may also be used. In general, the data storage unit 20 is physically located with the processor 18, so that unauthorized personnel cannot access information stored on the data storage unit 20.

A data output device 22 may be coupled to the processor 18 that is operable to provide suitably formatted information to a user. Accordingly, the data output device 22 may include a printing device that prints the suitably formatted information onto one or more paper sheets that are removable from the printing device. Alternately, the data output device 22 may be configured to provide the suitably formatted information on other media. For example, the data output device 22 may include a compact disk drive that is configured to write the information onto a transportable memory disk, such as a magnetic or optical disk. Although the processor 18 and the data storage unit 20 may be physically sequestered from the user of the PDDA 12, the data output device 22 is generally accessible to the user, so that the suitably formatted information may be retrieved by the user, as will be more fully described below.

With reference still to FIG. 1, the operation of the system 10 will now be described in detail. Individual users of the system 10, or alternately, groups of individual users are permitted access to executable software programs in the system 10 by entering identifying information into a PDDA 12. After access is granted, a session is begun. At the outset of the session, the user may select a guide for the session based upon visual representations of suitable guides presented to the user on the PDDA 12. The selected guide provides audio and visual information to the user during the session, and may describe selected subjects, such as an explanatory discussion of various diagnostic procedures, which may include a discussion of a diagnostic test for the presence of the HIV virus (or other STD's) in the user. The PDDA 12 may then present the user with one or more patient consent forms. The user may either provide consent by indicating acceptance on the PDDA 12, or indicate non-acceptance on the PDDA 12, thus denying consent to the described medical procedure. In either case, the user is then requested to submit responses to various questions that are directed to behavioral patterns and medical information that may be processed by the system 10 to determine a relative risk level for the user. The determined risk level reflects likelihood that the user will contract a communicable disease, such as the HIV virus. Since the PDDA 12 may be a PC tablet device, as described above, or another device that is suitably situated to facilitate individual privacy, such as a personal computer positioned in a home, the user is advantageously afforded a level of confidentiality that encourages a level of candor by the user typically not achievable in traditional interviewing environments that use a live interviewer. Further, the user may decline to answer selected questions, or may, in reply to selected questions, state that the user lacks sufficient knowledge to offer a reply. Since the PC tablet device may be ink-enabled, a user may also input written remarks and/or questions directly to the PC tablet device so that a user's remarks and/or questions may be adequately addressed in a subsequent interview or session.

Still other options may be made available to the user. For example, the user may be asked about medications that the user is taking. The user may therefore be asked to identify the medication based upon a name of the medication and/or a graphical image of the medication. Optionally, the user may also be asked to express a level of confidence in the medication using a sliding scale graphic and/or by expressing the level of confidence based on an alphanumerical or percentage scale.

When the user has completed submitting responses to at least a selected portion of the questions, the responses are processed by the system 10. Based upon the processed responses, one or more video presentations may be made available to the user that may provide pertinent information to the user. In particular, based upon the processed results, the video presentations may be advantageously targeted towards the user. The user may also be asked to provide responses concerning specific objectives that may be undertaken by the user to reduce the risk of contracting the HIV virus. The processed responses may also be used to provide feedback to the user regarding personal behaviors and/or practices that are regarded as affording an elevated level of risk to the user, or that provide a relatively low level of risk to the user. In any event, the general level of risk may be expressed in terms of symbology that reflects the risk level. The symbology may be suitably shaped and/or expressed in a suitable color to convey the risk level to the user. At the conclusion of the session, a copy of a disease avoidance plan may be provided to the user.

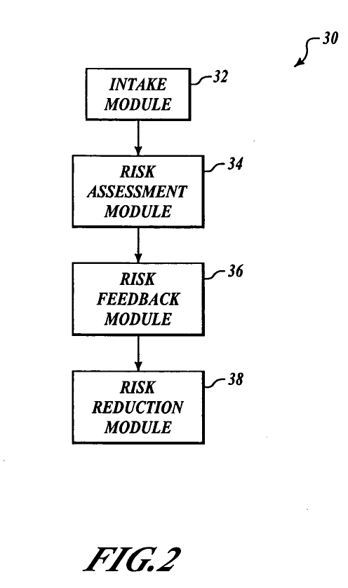

FIG. 2 is a block diagrammatic view of a software product 30 that provides disease risk assessment and/or education services, according to another embodiment of the invention. Briefly and in general terms, the software product 30 is configured to be hosted and executed by the processor 18 of FIG. 1. Alternately, the software product 30 may be partially hosted and executed by the processor 18, while other portions are hosted and executed within the PDDA 12. In either case, the software product 30 may be configured to generate various user interfaces that permit the user to communicate with the processor 18 and/or PDDA 12 by a selected tactile, graphical or audio interaction between the user and the PDDA 12. Alternately, various known-pointing devices such as a mouse, or a stylus, may also be used to facilitate interaction between the user and the PDDA 12.

The software product 30 includes an intake module 32 that requests selected identifying and statistical information to be input to the system 10 of FIG. 1. For example, the user may be prompted by means of a suitable interface to provide confidential information that will permit the user to access the system 10. For example, the user may be prompted to provide a predetermined password. Alternately, the user may be prompted to provide other identifying information generally known only to the user, which may include, for example, a middle initial of the user, a maiden name of the user's mother, a father's initials, or other similar information. Additionally, statistical information may also be acquired, such as a birth date of the user, the user's gender, a user's ethnic group, or other similar information.

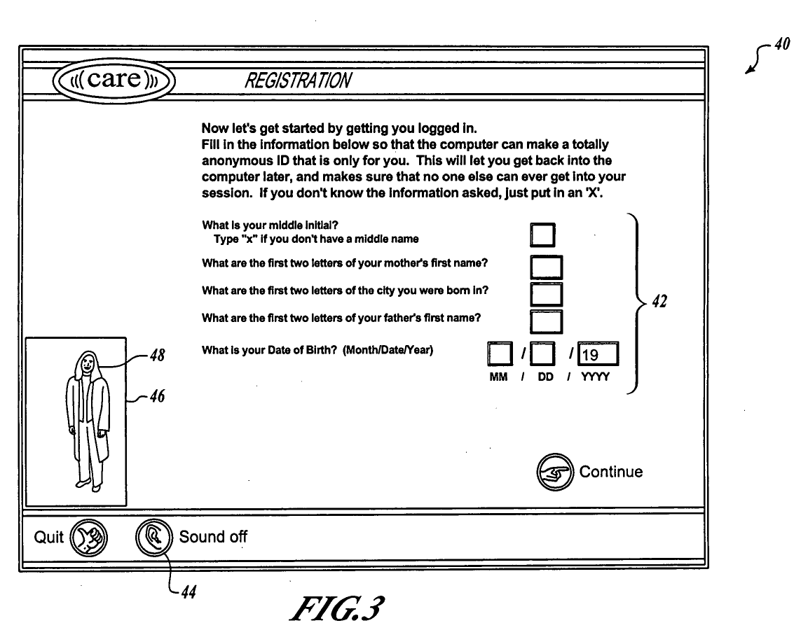

Referring now to FIG. 3, a user interface 40 generated by the intake module 32 is shown, according to another embodiment of the invention. The user interface 40 includes an information portion 42 so that a user of the interface 40 may enter various items of information. The interface 40 also includes a sound control icon 44, so that the user may activate, or alternately suppress, an audio presentation that explains the content of the information portion 42. The user interface 40 may also include a guide frame 46 that presents an image of a guide 48 that provides the audio presentation.

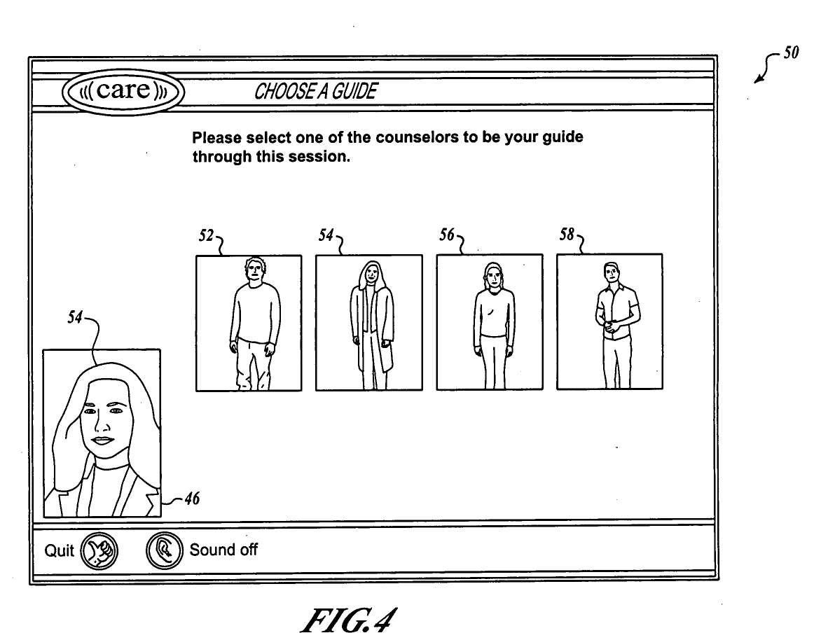

FIG. 4 is a user interface 50 generated by the intake module 32 of FIG. 2, according to another embodiment of the invention. The user interface 50 includes graphical depictions of guides 52, 54, 56 and 58 that may be selected by the user of the interface 50 as the guide that will be used throughout the execution of the software product 30. Once the user makes a selection, an image of the guide appears in the guide frame 46. For example, in FIG. 4, the user has selected the guide 54, and correspondingly, guide 54 appears in the guide frame 46.

Returning now to FIG. 2, the software product 30 includes a risk assessment module 34 that requests that selected risk information items be provided to the system 10 of FIG. 1. For example, the user may be prompted by means of a suitable interface to provide confidential information regarding the sexual behavior of the user and/or information regarding the use of intravenous drugs. The confidential information may also include other health related issues, such as the presence of serious health conditions, a psychiatric condition of the user, such as the presence of depression, as well as a user's recent experience with drugs, alcohol and other intoxicants.

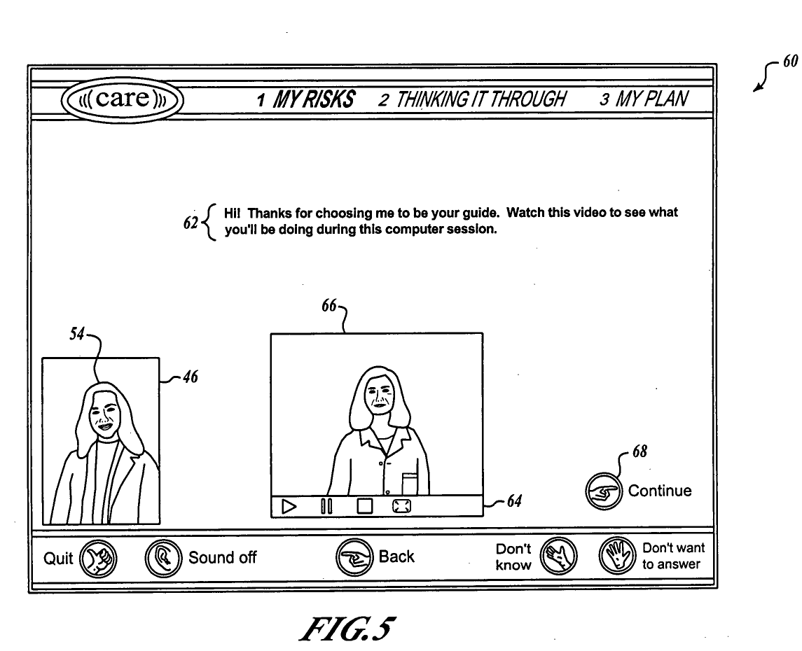

FIG. 5 is a user interface 60 generated by the intake module 32 of FIG. 2, according to another embodiment of the invention. The user interface 60 may present a user with one or more viewing options 62 that describe a video content that the user may view if the option 62 is selected. For example, and as shown in FIG. 5, the viewing option 62 asks the user to view video content regarding rapid HIV testing. The video content will automatically begin playing, and a tool bar 64 that is presented in a video window 66 may be used to allow a user to begin playing, pausing, or resizing the video content. Although the figure presented in the video window 66 is different from the selected guide 54, it is understood that the guide 54 may be used to describe the selected video content appearing in the video window 66. If the user does not desire to view the video content described in the viewing option 62, the user may select a continue option 68 on the user interface 60. Accordingly, another viewing option 62 may be presented to the user, and selected or rejected at the option of the user.

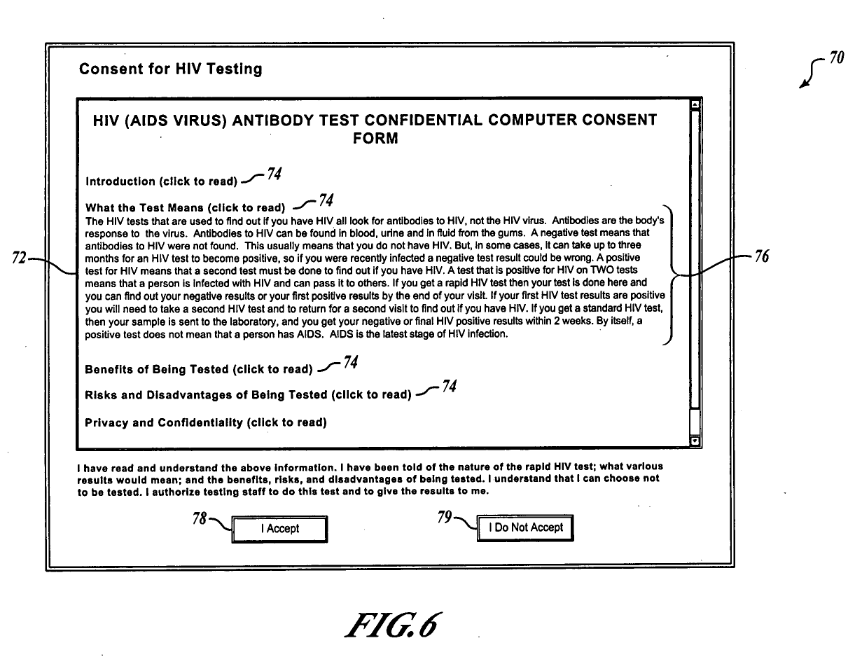

Turning now to FIG. 6, another user interface 70 generated by the intake module 32 is shown, according to another embodiment of the invention. The user interface 70 is generated in response to a user's viewing selections on the user interface 60 of FIG. 5. For example, in FIG. 6, the user is presented with a consent form 72 that comports with a general requirement to obtain informed consent prior to conducting any medical procedure on the user. The consent form 72 may include one or more general topics 74 relating to the consent form 72 that include a written content 76 associated with the selected topic 74. Accordingly, the user may view the written content 76, if desired, by actuating an icon associated with each of the topics 74. If the user desires to consent to the procedure described in the form 72, the user may actuate icon 88 that indicates acceptance, or alternately, if the user does not offer consent to perform the procedure, an icon 79 may be actuated.

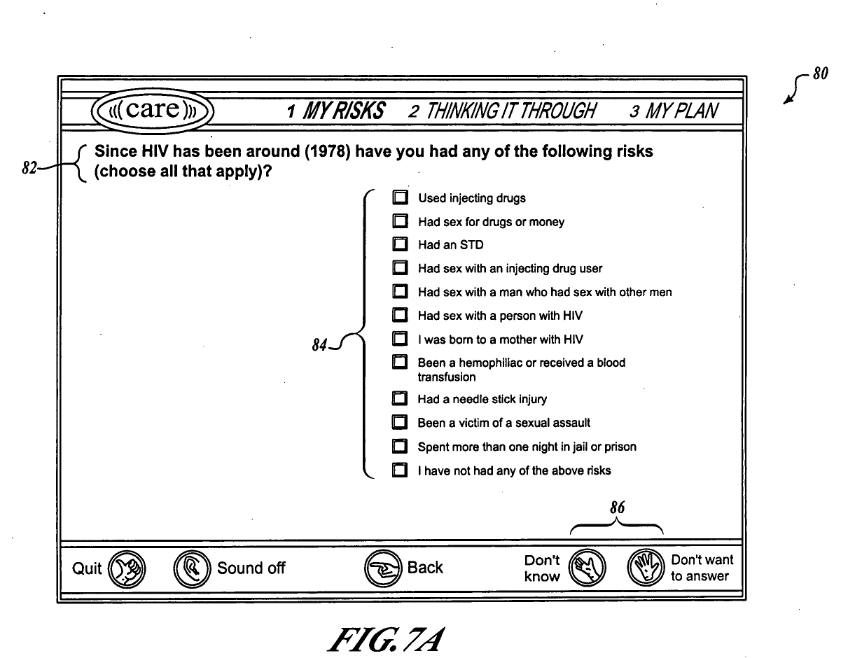

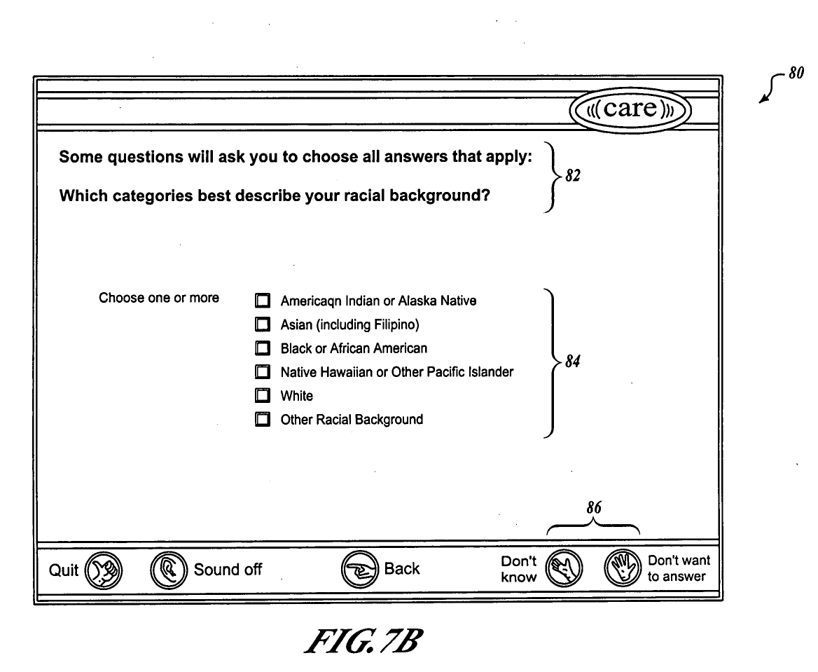

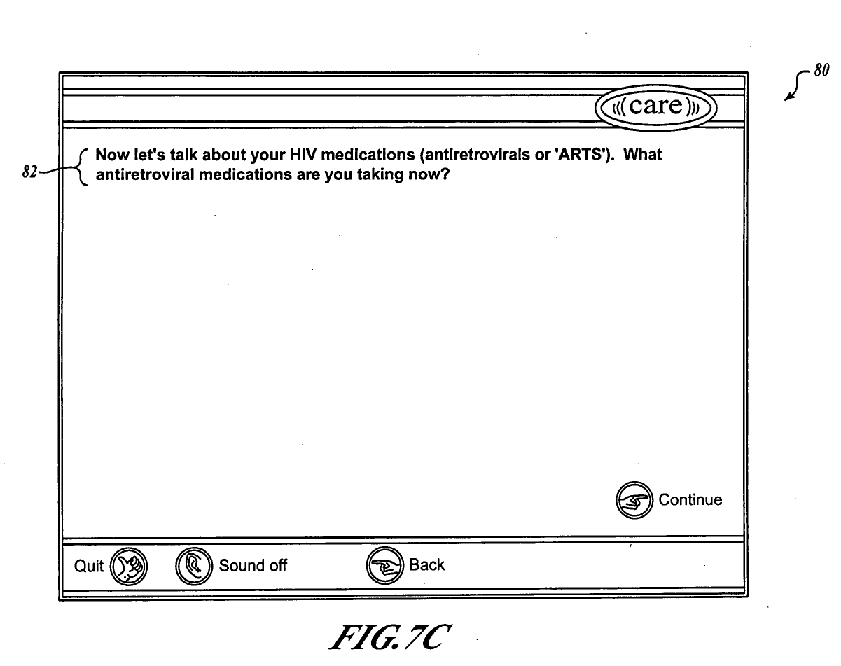

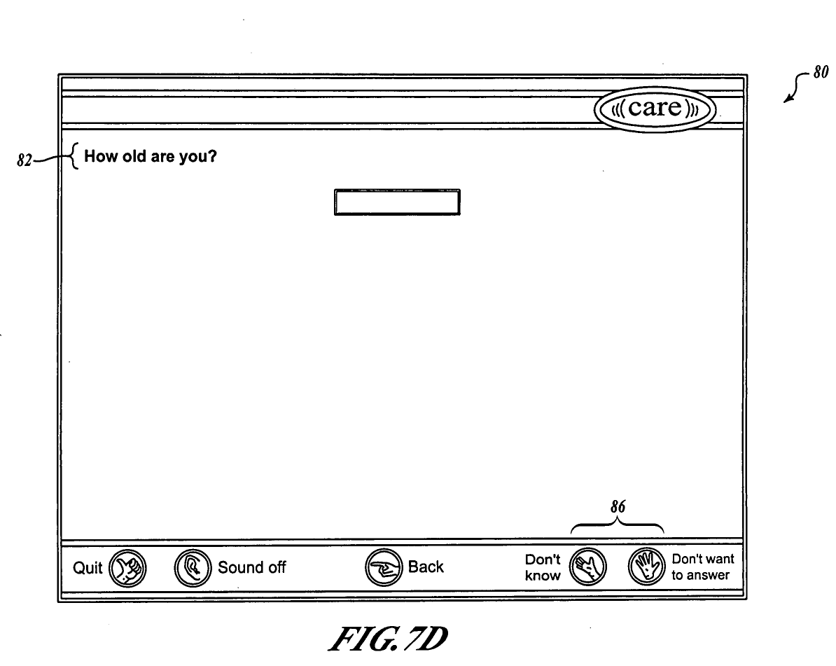

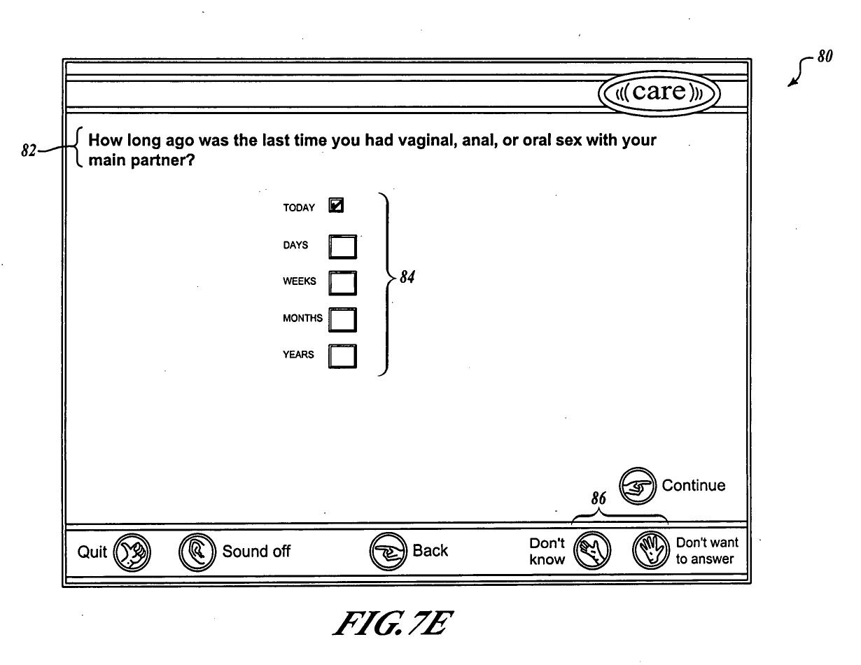

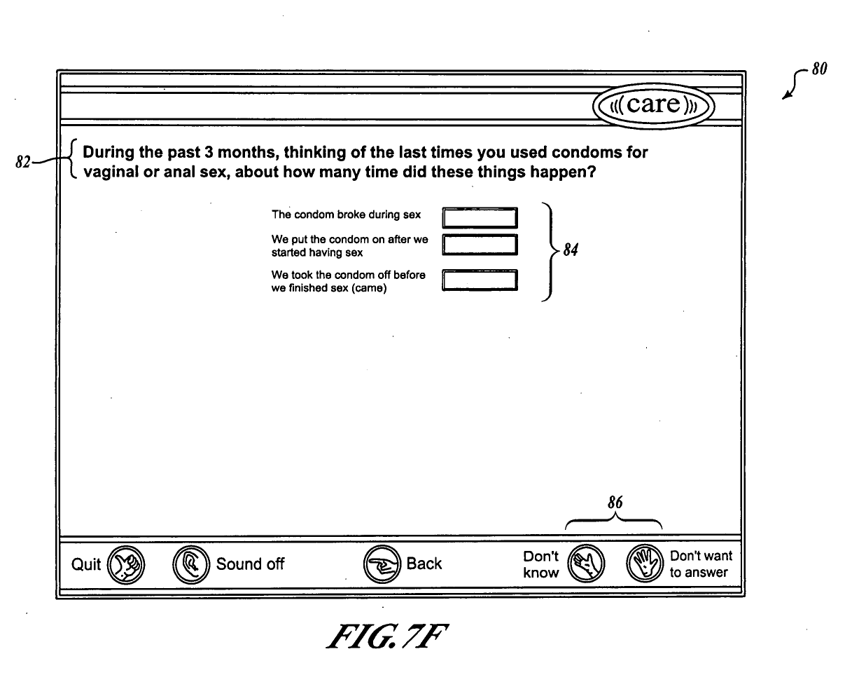

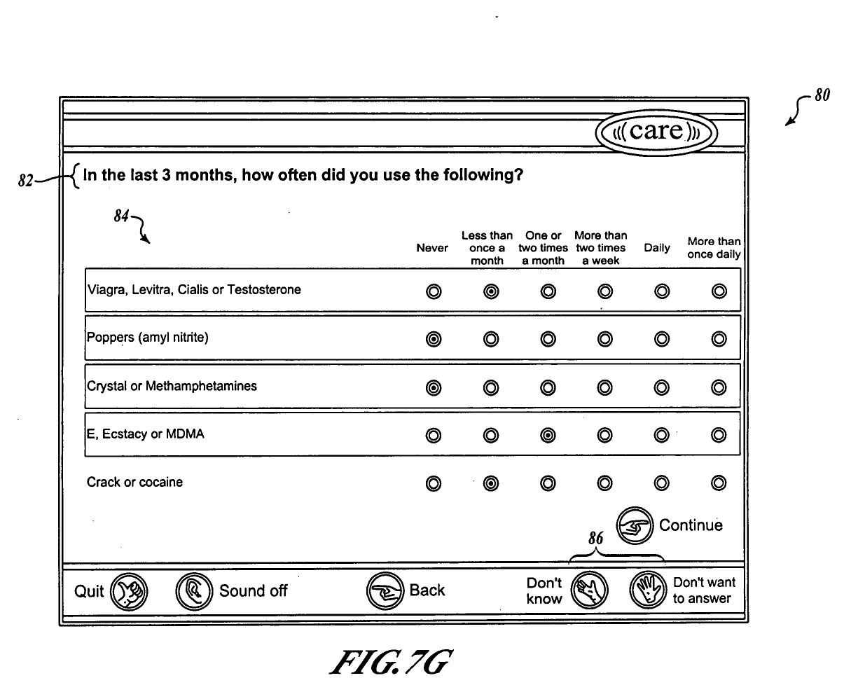

Referring now to FIG. 7a, another user interface 80 generated by the risk assessment module 34 is shown, according to another embodiment of the invention. The user interface 80 includes at least one risk information query 82 that poses a specific question relating to a risk assessment for the user. For example, the query 82 shown in FIG. 7a specifically requests information regarding behavior occurring since 1978 that is recognized as enhancing a risk that the user may have been exposed to the HIV virus. A confidential information block 84 allows the user to select various specific questions stemming from the query 82. For example, the confidential information block 84 may include a question such as whether or not the user has contracted a sexually transmitted disease (STD), and whether or not the user has used intravenous drugs. If the user cannot determine an answer, or alternately, for personal reasons, declines to answer any of the questions in the confidential information block 84, the user may access one or more reply options 86 on the user interface 80. The reply options 86 afford the user an opportunity to indicate that the user has considered a specific question in the block 84, but will not (or is unable to) provide a reply. For example, the reply options 86 may be configured to allow the user to reply that the user lacks sufficient information to answer (“Don't know”), or that the user chooses not to answer the specific question (“Don't want to answer”). The reply options 86 may allow a user to make a single selection or alternately, allow users to make multiple choices.

Still other user interfaces 80 are possible. For example, as shown in FIG. 7b, an interface 80 may be presented to the user to determine a racial background for the user. The background may include a cultural background for the user, or a language that the user is accustomed to. The interface 80 shown in FIG. 7c may be used to introduce the subject of medications that the user may be taking. For example, as shown in detail in FIG. 7c, the interface 80 references HIV medications that the user may be taking, while the interface 80 shown in FIG. 7d may be used to ascertain an age for the user. The interface 80 of FIG. 7e and FIG. 7f may be used to determine a sexual history for the user, and the user's sexual practices, respectively. FIG. 7g shows still another interface 80 that may be used to determine one or more medications or other substances that the user may be taking. The interface 80 shown in FIG. 7g may also be used to determine an administration frequency associated with the determined medications and/or substances.

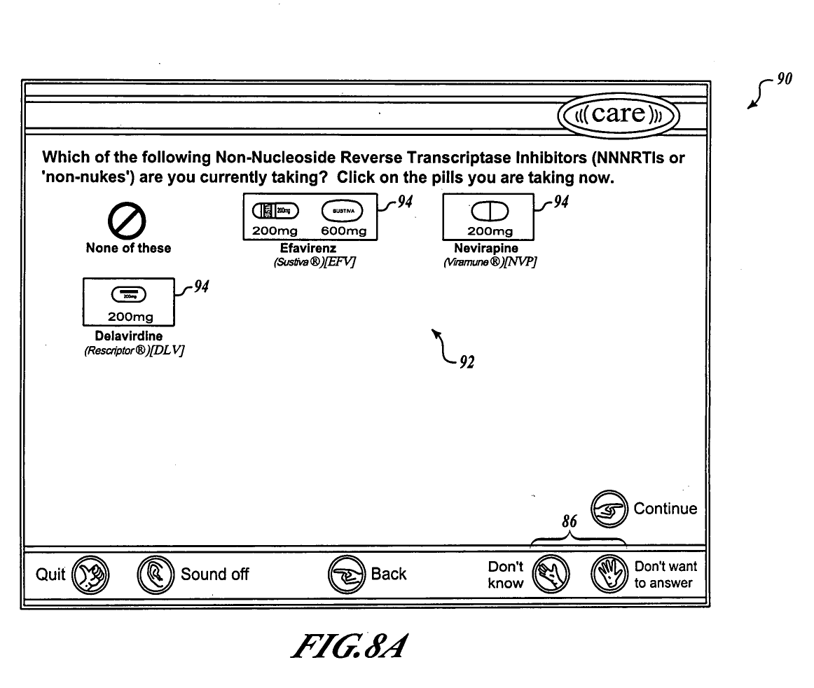

FIG. 8 is another user interface 90 that is generated by the risk assessment module 34 of FIG. 2, according to another embodiment of the invention. The user interface 90 allows the user to specifically identify selected medications that the user may be taking to address an HIV condition. Accordingly, at least one query 92, or a plurality of queries 92 are presented on the interface 90, which request a user to specifically identify a medication by a medication name, and/or by a graphical representation 94 of a medication dose.

As a follow-up to medication the questions shown in the interface 80 of FIG. 8a, FIG. 8b presents a user interface 90 that is generated by the risk assessment module 34 of FIG. 2, according to another embodiment of the invention. The user interface 90 may be used to receive information from the user regarding medications the user may be taking. A slider scale graphic 96 is provided to indicate the confidence level that the user has in their ability to take the identified medications as prescribed. A value of the users selection may be displayed as a small text area 97 adjacent to the slider scale graphic 96.

Returning again to FIG. 2, the software product 30 also includes a risk feedback module 36. The risk feedback module 36 generally provides a personalized assessment of the user's risk, and provides a foundation for assessing the user's risk in relation to the user's stated behavior.

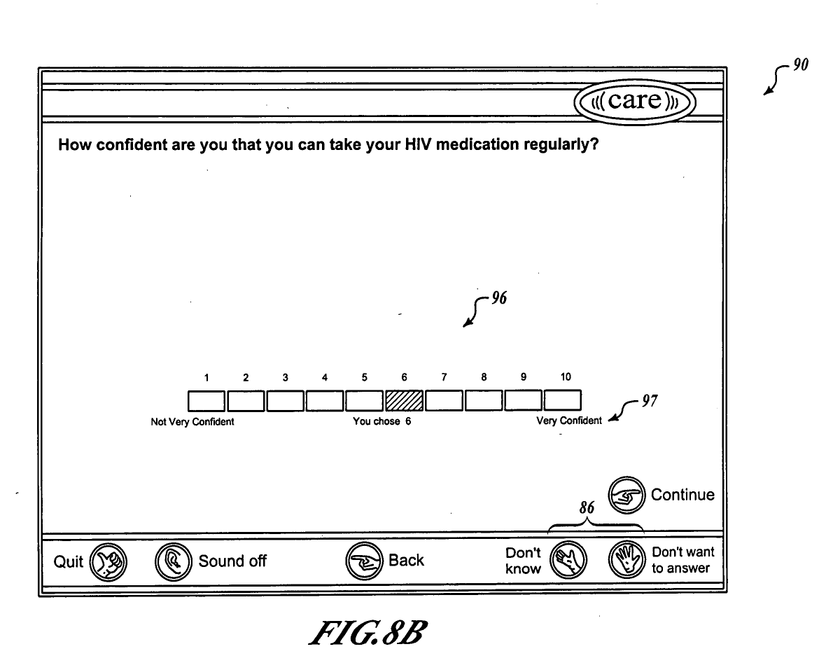

Referring now to FIG. 9, a user interface 100 generated by the risk feedback module 36 is shown, according to another embodiment of the invention. The user interface 100 includes an introductory statement that introduces the subject matter presented on the interface 100. For example, the interface 100 shown in FIG. 9 introduces a relative risk scale 104 that allows the user to visually assess the risk level associated with the disclosed behavioral characteristics. The risk scale 104 may include risk icons 106 that graphically illustrate a level of risk. For example, an icon 106 that is associated with a relatively low risk level may have a first color and/or a first geometrical shape. An icon 106 that is associated with an intermediate risk level may have a second color and/or a second geometrical shape, while an icon 96 that is associated with a relatively high risk level may have a third color and/or a third geometrical shape.

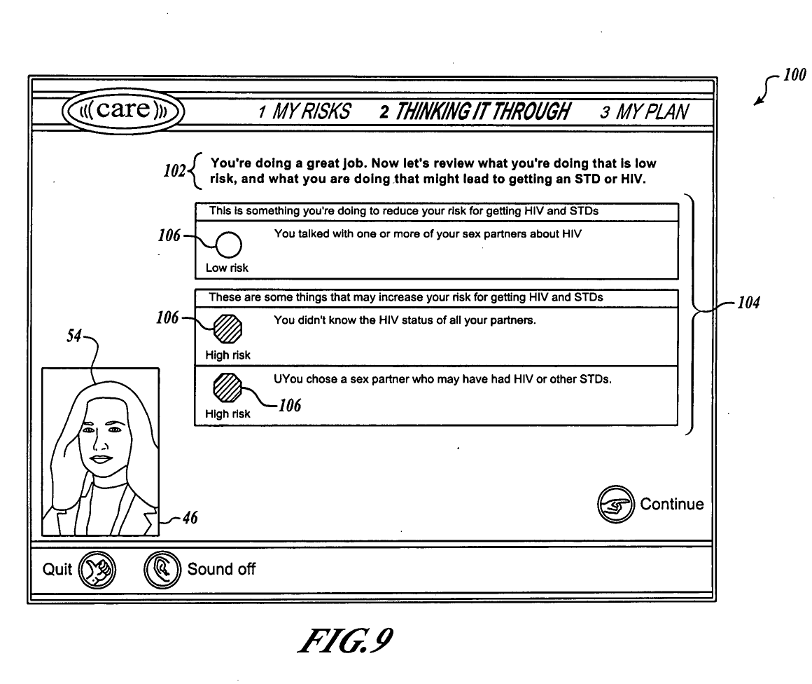

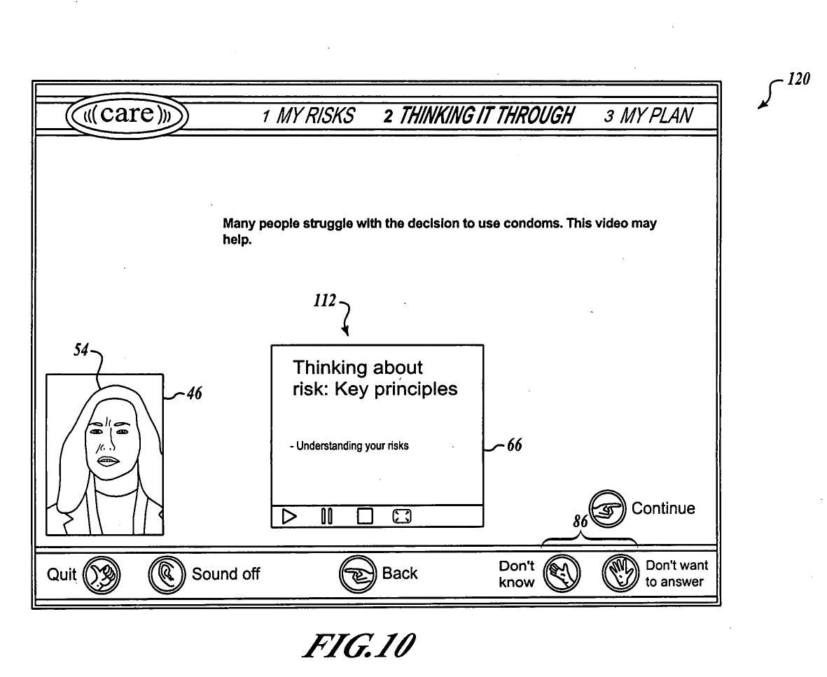

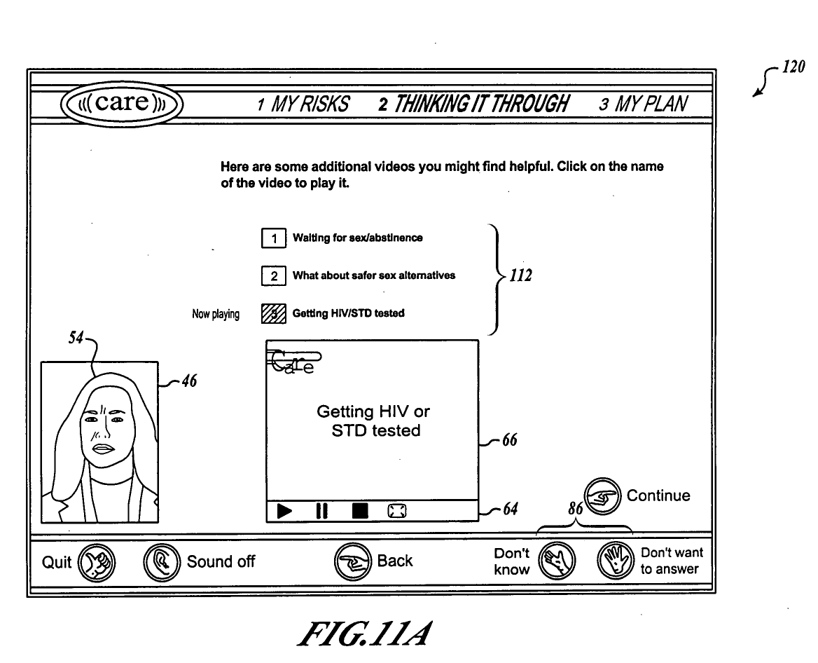

FIG. 10 is still another user interface 120 that is generated by the risk feedback module 36 of FIG. 2, according to another embodiment of the invention. The user interface 120 may be configured to present the user with a plurality of video content options 112 that have been previously correlated with the user's disclosed behavioral characteristics. Upon selection of a selected one of the options 112, the user views the video content associated with the option 112 in the video window 66. For example, the user may be presented with options 112 that allow video content associated with condom use to be viewed. Still other options 112 may be presented by the user interface 120. For example, as shown in FIG. 11a, an option 112 may be selected that allows video content associated with abstinence, safe sex alternatives, and other similar subject matter to be viewed by the user. Although the interface 120 shown in FIG. 11a allows three selections to be made by the user, in another embodiment, as shown in detail in FIG. 11b, multiple selections may be presented to the user that may include “thumbnail” descriptions of the selections, and may also include a brief written description of the selection.

Returning yet again to FIG. 2, the software product 30 also includes a risk reduction module 38. The risk reduction module 38 generally allows the user to narrow a selected risk area and provides a plan that includes goals that the user selects as possible goals.

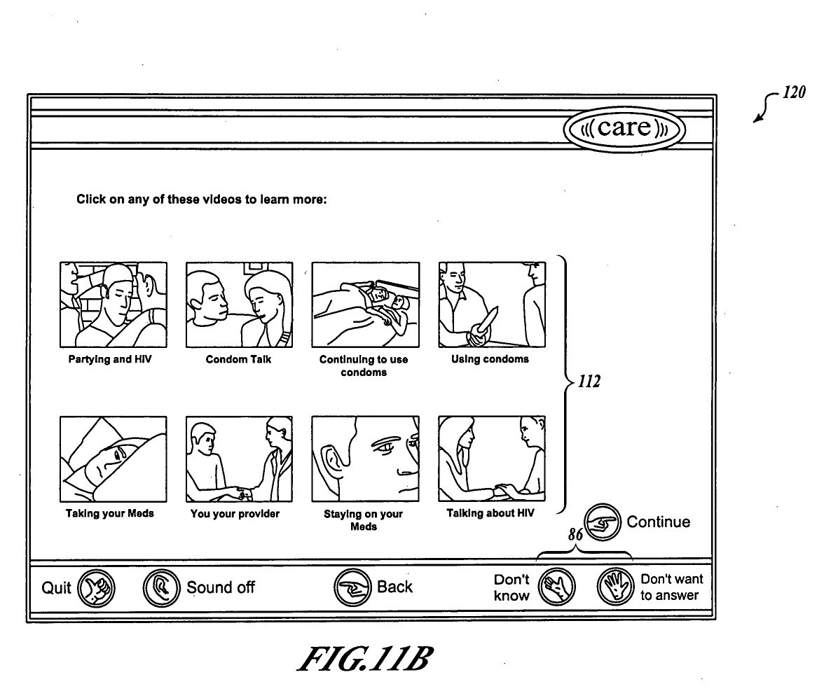

With reference now to FIG. 12, a user interface 130 generated by the risk reduction module 38 is shown, according to another embodiment of the invention. The user interface 130 provides a plurality of queries 132 that permit the user to focus on areas the user may pursue in reducing risk. For example, as shown in FIG. 12, the user may select options that range from abstinence to reducing drug and alcohol use.

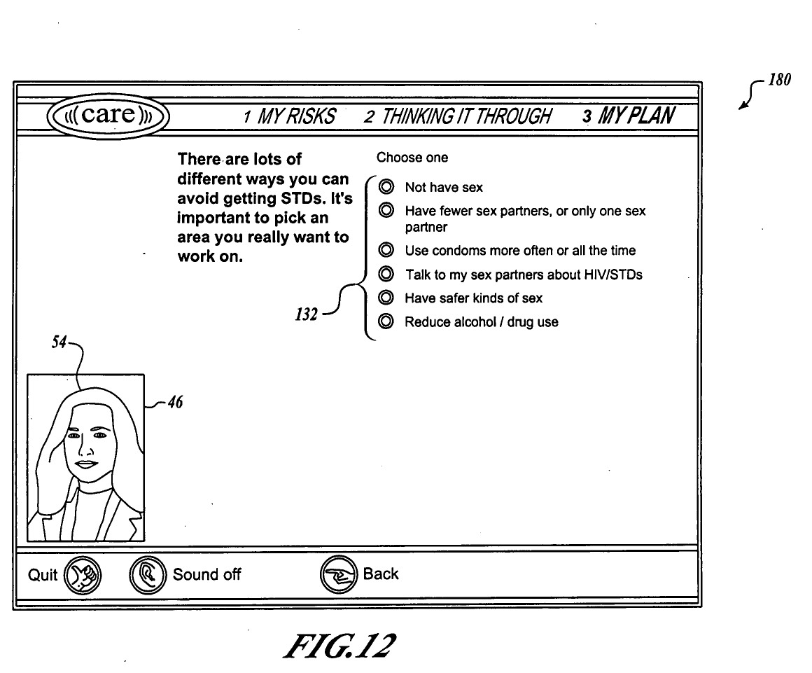

FIG. 13 is another user interface 140 that may be generated by the risk reduction module 38 of FIG. 2, according to another embodiment of the invention. The user interface 140 elaborates still further steps 142 that the user may undertake in order to achieve a proposed plan. For example, the user may commit to undertake HIV testing with the user's sexual partner, or merely discuss the possibility of HIV testing.

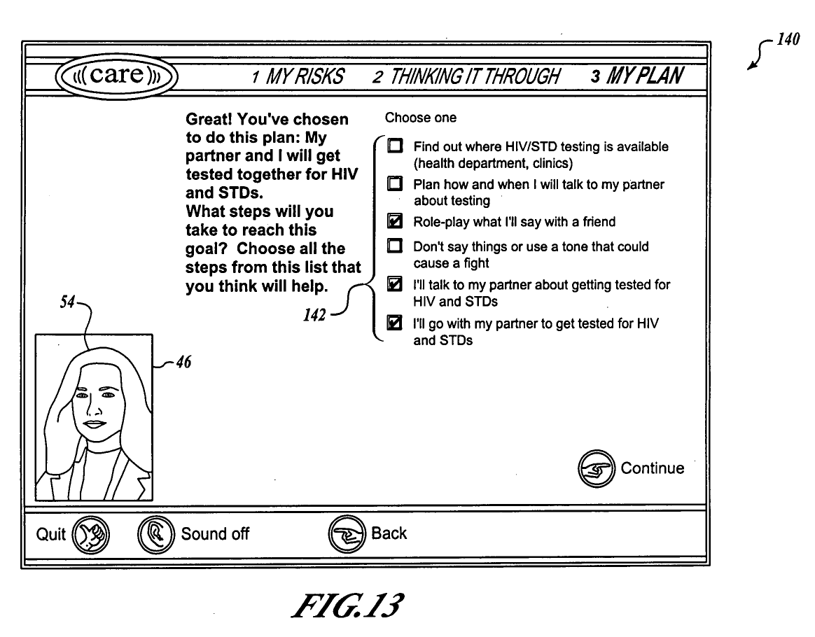

With reference now to FIG. 14, a user interface 150 generated by the risk reduction module 38 is shown, according to another embodiment of the invention. The user interface 150 provides a plurality of queries 152 that permit the user to focus on areas the user may pursue in reducing risk. For example, as shown in FIG. 14, the user may focus upon the user's intentions and confidence level in achieving risk reduction goals. For example, the user interface 150 shown in FIG. 14 provides an opportunity to the user to express a reply to queries 152 related to personal shortcomings, such as a need to acquire further interpersonal skills. In addition, other queries 152 may be directed to potential difficulties with other, such as a sexual partner.

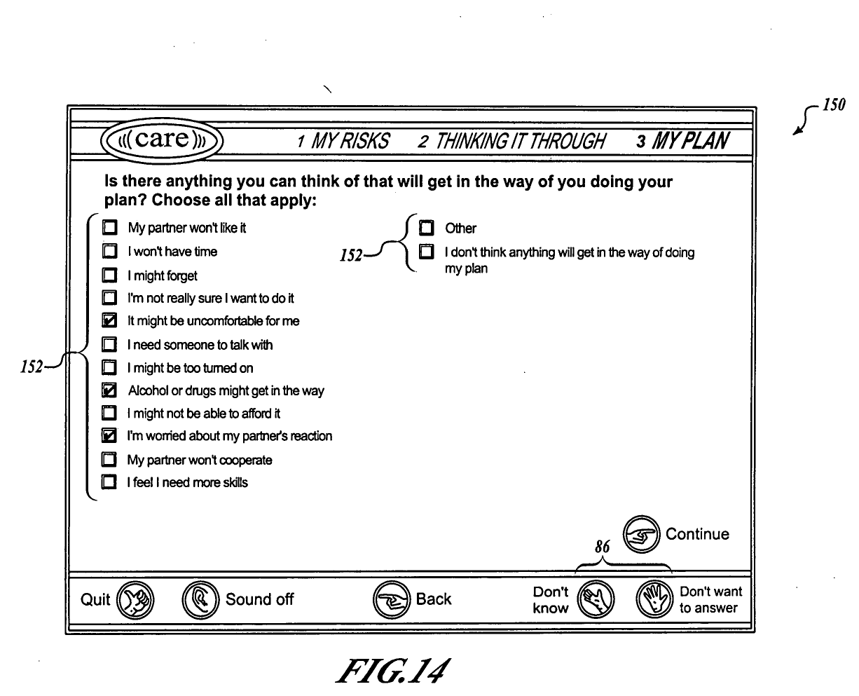

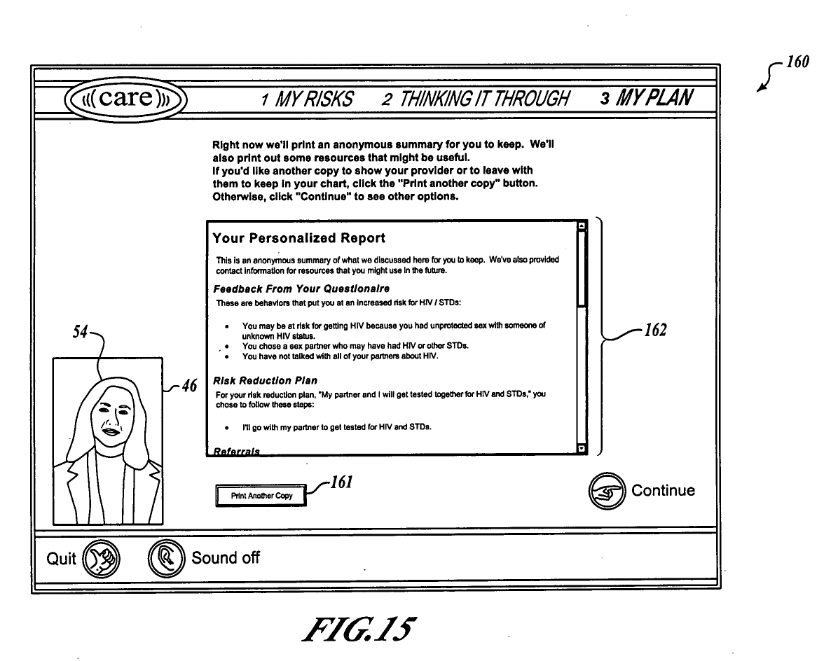

FIG. 15a is another user interface 160 that is generated by the risk reduction module 38 of FIG. 2, according to another embodiment of the invention. The user interface 160 presents the user with a personalized report 162 that is prepared by processing the information gathered during the execution of the previous software modules. The personalized report 162 includes specific recommendations relating to specific risk reduction behavioral goals and personal conduct guidelines that comport with the user's intentions and confidence level in achieving the stated goals. If the user desires a private copy of the personalized report 162, either for the user's personal benefit, or for use in a counseling session with a counselor, the user may actuate a copy button 164 to generate a copy.

With reference now to FIG. 15b, a block diagrammatic view of a software implementation 200 for a method of disease risk assessment and education is shown, according to another embodiment of the invention. In general terms, the software implementation 200 may be implemented using known commercial software applications and programming languages. For example, content associated with the implementation 200 may be included in a spreadsheet application such as EXCEL, available from Microsoft Corporation, although other suitable spreadsheet applications are also available, and may also be used. In the present context, content generally refers to survey questions presented to the user in one or more of the foregoing user interfaces, as well as other text matter, such as responses returned to the user in response to the user responses.

The software implementation 200 includes a logic engine assembly module 202, that further includes a logic engine that provides the logical rules implementation that drives at least the content. For example, the logical rules implemented in the logic engine assembly module 202 may provide suitable questions and allowable answers to the user. The logic engine assembly module 202 may also include a data access layer that is used to read and/or write information to a disk storage device, such as the data storage unit 20 of FIG. 1. Although not shown in FIG. 15a, the assembly module 200 may also include a session assembly module, that defines the structures and methods that create a session for the user.

The software implementation 200 also includes a main application assembly module 204 that is configured to provide all of the forms used in the implementation 200, and further may provide suitable instructions that allow a user to navigate through the implementation 200. A control assembly module 206 includes various controls that are employed in the implementation 200. For example, the control assembly module 206 may include an implementation that controls the analog and/or decimal slider scale 96 employed in the user interface 90 of FIG. 8b. Other controls may also be included in the control assembly module 206, which may include an implementation that controls the selection of various selected videos for viewing by the user, as shown in detail in the user interface 120 of FIG. 11b.

Still referring to FIG. 15b. the implementation 200 includes a question assembly module 208 that includes various survey question types that are employed in the application. Each question type has a distict class implementation. For example, the question assembly module 208 includes a derived class that may include ‘date’ type questions, while other classes include derived classes related to ‘how long’ or ‘how many’ type questions. Still another class provides a derived class directed to questions that may lead to the display of one or more videos. The question assembly module 208 may also provide an implementation for skip and response classes also. The response class tracks name value question pairs to determine if a response should be gathered from the user. The skip class implements the question routing logic used during the session, which permits non-answered and/or non-pertinent questions to be skipped.

The implementation 200 also includes an event session assembly module 210 that is configured to build the survey questions and responses at an execution time so that they may be selected and/or displayed by the user. Once the user has answered a question and has opted to continue with the survey, the skip logic (as provided in the question assembly module 208) informs the system regarding which question to present to the user next.

The foregoing software implementation 200 has been implemented in software that is included in CD ROM disks included with the present application, and entitled: “Systems, Methods and Computer Product for Disease Risk Reduction and Assessment-Source Code” and “Systems, Methods and Computer Product for Disease Risk Reduction and Assessment-Software Program”, which CD-ROM software content is incorporated in the present application by reference.

A survey tool according to another embodiment of the invention will now be discussed in detail. The survey tool may be implemented as a WinForms application designed for a Windows computer, laptop, or tablet PC. The survey tool may be subdivided into five basic projects or assemblies. The details of each assembly will be described in the following sections. The five assemblies are: A QAR_Engine assembly that is a ‘base’ application class; a Main App assembly, which includes application forms and ‘main’ program code; A CASIC Control assembly, that includes a custom user interface (UI) controls class used by the application; a QuestionTypes assembly that includes the classes which implement survey questions, and a CareSession assembly that includes survey content, including question text, media paths, and skip logic.

The QAR_Engine assembly contains the bulk of the application code broken down into three base classes. It also contains the resource file which holds the text strings used for the survey questions and other text strings within the system. These strings are collectively the question text, question response(s) text, and other text strings used within the system. The three classes which this module implements are a Facade class, which contains the implementation and business logic which drives the survey questions. It controls the survey session object which governs the survey questions and allowable answers. A Session class is

an abstract class that defines the structures and methods used to create a session instance that will contains the actual content of the application. A QAR_Engine is the core of the CARE tool. It consists of a Data Access Layer (DAL) and a logic engine. The DAL is used to read/write information to disk. User session data, survey question responses, and Risk Reduction Plan steps are all persisted within the system. The logic engine component contains the implementation and business logic which drives the survey questions. It controls the survey session object which governs the survey questions and allowable answers.

The MainApp assembly includes all of the forms used by the application and starts the application using a MainApp Main( ) function which instantiates the mainApp class and runs the application. After the initialization is complete the user will be left with a running instance of the LoginForm. Once the login process has been completed the system will close the Login form and run an instance of the QuestionConsumingForm. This form is used for the remainder of the survey. As the user navigates through the survey controls containing the survey questions are added and removed from the form.

The CASICControl assembly includes the custom controls that were written for the application. These controls include the following: A BaseControl that controls all of the other question controls are derived from an AnalogListQControl, that is a UI implementation of the Analog slider scale. The scale consists of a color-coded bar with tick marks at regular intervals. Users click along the bar to make their selection, and the selected value is displayed under the bar. An AnalogDecimalQControl is a UI implementation of the Decimal slider scale. Functionally similar to the analog scale, the only difference is the decimal scale's bar is broken up into an arbitrary number of discrete parts.

A ContainerListControl is a UI implementation of the Container question without shared lists.

A ContainerShareListControl is a UI implementation of the Container question with shared lists.

A DateTimeQControl is a UI implementation of the datetime question type.

A HowLongQControl—UI implementation of the datetime question type.

A HowManyQControl is a UI implementation of the datetime question type.

A ListQControl is a UI implementation of the list question type. Supports both single and multiselect.

A LongListControl is a UI implementation of the list question type. Supports lists too long for the standard ListQControl.

A PictureListControl—UI implementation of the Image List question type.

A PopUpKeyboard—These controls were written specifically for the Tablet PC integration and allow stylus users to enter either numeric or text data.

A TextQControl—UI implementation of the text question type

A VideoListQControl—Allows users to select multiple videos for viewing

A VideoQControl—displays a single video question

A ViralLoad—For HIV+users, the application will track their virus load over multiple visits. The virus load graph will display the values for all previous visits in a chart format.

A QuestionTypes assembly includes the survey question types that are used by the application. Each question type has its own class implementation and is derived from the ASCISBase class. The complete list of classes within this assembly includes:

A BaseQuestion—shared implantation base class, used for label questions and simple numeric answers.

A DateTimeQuestion—derived class for ‘Date’ questions.

A HowLongQuestion—derived class for ‘How Long . . . ’ questions.

A HowManyQuestion—derived class for ‘How Many . . . ’ questions.

A TextQuestion—derived class for questions that ask the user for a text response.

A ListQuestion—derived class for questions that ask a user to select a single list item.

A MultipleSelectListQuestion—derived class for questions that ask a user to select one or more list itemsAnalogBaseQuestion—derived class for questions that ask users to select from an analog scale. The analog slider questions are used to gauge user's confidence, mostly on a 0-100% scale, although the question is capable of arbitrary scale numbers.

A DecimalScaleQuestion—derived class for questions that ask users to select from a scale with distinct items. Similar to the analog scale, the only difference is the decimal scale's bar is broken up into an arbitrary number of discreet parts.

A DecimalQuestion—derived class for questions with decimal (non-integer) values

An ImageListQuestion—derived class for questions that ask users to choose from a number of images.

A ContainerQuestion—derived class for container questions without shared list sub-questions.

A SharedListContainerQuestion—derived class for the container questions with a number of list sub-questions with identical response types.

VideoQuestion—derived class for questions that display one or more videos

In addition this class provides the implementation for the Response and Skip classes as well. The response class tracks name value question pairs to determine if a response should be gathered from the user. The skip class implements the question routing logic used during the survey session.

A CARESession assembly is an instance of the abstract class QAR_Engine.Session. It is used to build the survey questions and responses at runtime and select/display the various survey questions and answers. Once a survey respondent has answered a question and chosen to continue, the navigation or ‘skip’ logic tells the system which question to process next.

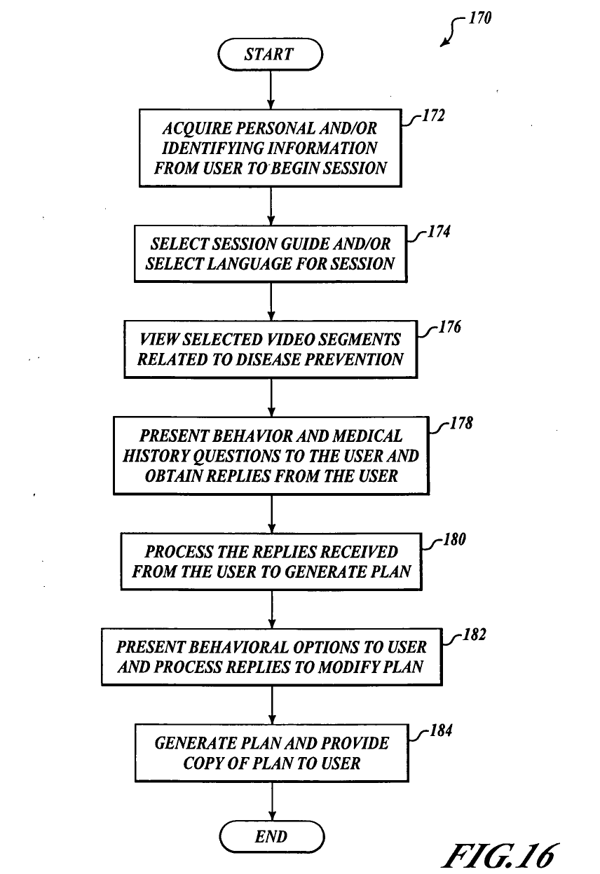

FIG. 16 is a flowchart that will be used to describe a method 170 of disease risk assessment and education, according to another embodiment of the invention. At block 172, personal and/or identifying information is acquired from the user at the outset of the session. The information may include a confidential password that is known only to the user, or it may involve other information such as a mother's maiden name, a father's initials, or other similar information. At block 174, a session guide may be selected by the user. Since the session guide provides audio and visual content to the user, the method 170 advantageously allows users with limited language skills to use the method 170. At block 176, the user views selected video segments relating to disease prevention. For example, a selected video segment may provide information regarding testing the user for the presence of the disease. At the conclusion of the video segment, the user may be asked to provide consent for a medical test to determine the presence of the disease in the user. At block 178, the user is presented with a plurality of questions relating to the behavioral and medical history of the user. For example, the plurality of questions may be directed to the sexual history of the user. In response to the plurality of questions, the user may decline to answer, or may indicate that the user is unable to answer due to a lack of knowledge. Additionally, a user may identify any medications that the user may be taking to address a specific disease condition. At block 180, the replies received from the user are process to generate a plan. Behavioral options may then be presented to the user, and replies obtained from the user. Accordingly, the further responses may also be processed to modify the plan, as shown at b lock 182. At block 184, a final plan is generated and a copy of the plan is provided to the user.

Still referring to FIG. 16, the method 170 may be repeated by the user so that additional items may be added or deleted from the plan. Thus, modifications to the plan may be made within a selected period of time. In a specific embodiment, the selected period of time is approximately about sixty days. If more than the selected time period elapses, the method 170 may not be modified. Instead, the user must compile a new plan.

While various embodiments of the invention have been illustrated and described, as noted above, many changes can be made without departing from the spirit and scope of the invention. For example, although the foregoing embodiments of the invention have been directed to educational content, assessment and planning related to individuals having, or at least at risk of contracting HIV and/or STD'S, it is nevertheless understood that the various disclosed embodiments may also be advantageously employed to educate, evaluate and prepare risk-reduction and/or behaivioral change plans for individuals which have, or are at risk of developing other disease conditions, such as diabetes, heart disease, or other organic illnesses. In particular, the foregoing embodiments may be advantageously employed in cases where behavioral components are present, such as in weight reduction programs, smoking reduction and/or elimination programs, alcohol and/or drug treatment programs, or other similar programs. Accordingly, the scope of the invention is not limited by the disclosure of the various embodiments. Instead, the invention should be determined entirely by reference to the claims that follow.

What is claimed is:

1. A system for computer-assisted disease risk assessment and education, comprising: a processor configured to generate at least a plurality of questions directed to a disease risk assessment for a user, and based upon responses received from a user, operable to generate one or more plans configured to prospectively guide the risk behavior and sexual activity of the user; and at least one personal data entry and display device (PDDA) communicatively coupled to the processor, the PDDA being operable to at least display the plurality of questions and to accept corresponding responses from the user.

2. The system of claim 1, wherein the processor further comprises one of a mainframe computing device, and a personal computing device.

3. The system of claim 1, wherein the at least one PDDA further comprises a tablet personal computing device that is configured to accept the corresponding responses on a display surface of the tablet personal computing device.

4. The system of claim 1, further comprising a communications system that is interposed between the one or more PDDA's and the processor that is operable to communicatively couple the processor to the one or more PDDA's.

5. The system of claim 4, wherein the communications system is configured to permit the processor to wirelessly communicate with the one or more PDDA's.

6. The system of claim 1, further comprising a database coupled to the processor that is configured to securely store responses received from a user, and the one or more plans.

7. The system of claim 1, wherein the PDDA is configured to display selected motion and audio content to the user that is communicated to the PDDA from the processor.

8. The system of claim 7, wherein the PDDA is further configured to accept a hand-written entry, and to communicate the entry to the processor.

9. The system of claim 1, further comprising a data output device coupled to the processor that is configured to generate a copy of the one or more plans.

10. A software product to provide disease risk assessment and education services, comprising:
an intake module configured to request selected identifying information from a user;
a risk-assessment module configured to request selected disease risk information from the user;
a risk feedback module configured to generate a personalized assessment that indicates at least a disease risk of the user; and
a risk reduction module configured to generate at least a risk reduction plan for the user.

11. The software product of claim 10, wherein the intake module is further configured to generate a user interface that is operable to accept at least one of a confidential password and personal information known to the applicant.

12. The software product of claim 11, wherein the user interface further includes graphical depictions of guides which are selectable by the user to provide explanatory information to the user.

13. The software product of claim 10, wherein the risk-assessment module is further configured to generate a user interface that is operable to provide at least one of an informational video presentation, a medical consent form, and at least one question directed to a disease risk status of the user.

14. The software product of claim 13, wherein the user interface is further configured to request at least one response from the user that is directed to medications that the user may be using to address a disease condition.

15. The software product of claim 14, wherein the user interface is configured to present the user with at least one graphical depiction of a medication, and is further configured to permit a user to express a level of confidence regarding the perceived effectiveness of the medication.

16. The software product of claim 10, wherein the risk feedback module is further configured to generate a user interface that is operable to provide the user with one or more educational video content options that are correlated with the user's one or more responses provided to the risk assessment module.

17. The, software product of claim 16, wherein the user interface include one or more graphical icons that are configured to visually convey a risk level to the user.

18. The software product of claim 10, wherein the risk reduction module is further configured to generate a user interface that is operable to present the user with a plurality of options that are directed to assessing an intention and a confidence level for the user in formulating the risk reduction plan.

19. The software product of claim 18, wherein the user interface is further configured to generate a printed copy of the risk reduction plan for the user.

20. A method of disease risk assessment and education; comprising:
acquiring at least one identifying characteristic from a user;
viewing one or more selected video segments directed to disease prevention in the user;
generating a plurality of questions directed to a behavioral and medical history of the user; and
processing the corresponding replies to the plurality of questions and generating a plan directed to avoiding exposure to the disease.

21. The method of claim 20, wherein acquiring at least one identifying characteristic from a user further comprises at least one of selecting a session guide to provide audio and visual content to the user, and selecting a language that is understandable to the user.

22. The method of claim 20, wherein viewing one or more selected video segments directed to disease prevention further comprises viewing a video segment that provides information related to a diagnostic procedure, and providing a consent form for the procedure.

23. The method of claim 20, wherein generating a plurality of questions directed to a behavioral and medical history of the user further comprises presenting the user with at least one question regarding a medication that the user may be taking, and at least one question regarding a psychological condition of the user.

24. The method of claim 23, wherein presenting the user with at least one question regarding a medication that the user may be taking further includes providing the user with a graphical depiction of the medication.

25. The method of claim 20, wherein processing the corresponding replies to the plurality of questions and generating a plan directed to avoiding exposure to the disease further comprises presenting one or more behavioral options to the user, and modifying the plan based upon the corresponding responses to the options.
